(19) United States
(12) Patent Application Publication
(10) Pub. No.: US 2022/0211064 A1
(43) Pub. Date: Jul. 7, 2022

(54) CHEESECAKE AND METHOD OF PRODUCING SAME

(71) Applicant: FrieslandCampina Nederland B.V., Amersfoort (NL)

(72) Inventor: Jeroen Theodorus Maria DIJKGRAAF, Wageningen (NL)

(21) Appl. No.: 17/702,618

(22) Filed: Mar. 23, 2022

Related U.S. Application Data
(63) Continuation of application No. PCT/EP2020/076466, filed on Sep. 23, 2020.

(30) Foreign Application Priority Data
Sep. 24, 2019 (EP) 19199154.6

(51) Int. Cl. A23C 19/09; A21D 2/26; A21D 2/16; A21D 2/18; A21D 10/00; A21D 13/13

(52) U.S. Cl. CPC A23C 19/0917; A23C 19/0912; A21D 2/263; A21D 13/13; A21D 2/186; A21D 10/005; A21D 2/165

(57) ABSTRACT

The invention relates to a baked cheesecake comprising a crust and a filling wherein the filling comprises 2-7 wt. % , based on the dry weight of the filling, of whey protein preferably derived from a whey protein source comprising at least 34% whey protein by weight. The invention is based on the finding that the use of certain whey proteins are able to reduce or even prevent crack formation in the filling of baked cheesecake. The invention is further related to a method of preparing a baked cheesecake, wherein use is made of specific whey proteins. Further, the invention pertains to a powdered ingredient composition suitable for preparing a cheesecake filling that comprises, based on total weight of the composition, 4-30 wt. % of a whey protein source preferably comprising at least 34% whey protein by weight, 25-45 wt. % fat and 25-50 wt. % carbohydrates.

### CROSS-REFERENCE TO RELATED APPLICATIONS

The present application is a continuation application of PCT/EP2020/076466 filed Sep. 23, 2020, which claims priority to European

Patent Application No. 19199154.6 filed Sep. 24, 2019, the entire contents of which are incorporated herein by reference.

### FIELD OF THE INVENTION

The invention pertains to a bake-stable cheesecake, and a method for preparing a cheesecake. The invention furthermore pertains to a powdered ingredient composition comprising whey protein suitable for preparing cheesecake, and the use of whey proteins for the reduction or prevention of cracks in baked cheesecake fillings.

### BACKGROUND TO THE INVENTION

Cheesecake is an indulgent food product comprising a cream cheese based filling and a crust supporting the filling.

Cheesecake is traditionally home-made from fresh ingredients. The filling is made from cream cheese, sugar, (sour) cream, whole eggs, lemon juice or citric acid, (modified) corn starch and/or wheat flour, and optionally vanilla aroma.

The crust is normally prepared from a dough of crumbled cookies, Graham crackers or biscuits, and melted fat (e.g. butter). Sometimes sugar is added to the crust ingredients to provide a glassy character upon baking to prevent the crust from becoming soggy by water-uptake.

Cream cheese is conventionally prepared by standardizing cream to 10-20% milk fat, pasteurizing the cream (e.g. at 66-68° C. for 30 minutes or at 72-75° C. for 30-90 seconds), homogenizing, and culturing at about 30° C., and inoculating with a starter culture, until a pH of about 4.6 is reached and a curd is formed. The curd is stirred and the whey is drained from the curd mass. The resulting curd mass is pressed and packed, and stored cool. Nowadays an alternative, ultrafiltration method is also used to separate the curd from the whey.

The sensory and visual aspects of cheesecake are highly appreciated by consumers and it is considered to be a luxury food product. Cheesecake, in particular the filling, has specific requirements regarding its firmness. It needs to be firm enough to be cut or sliced, but, on the other hand, it may not be too firm to negatively affect mouthfeel. In industrial production, additionally, it must be able to withstand freezing after large scale production, and thawing at the consumers end without losing its delicate sensory properties. The filling has a pleasant, slightly sour taste (pH around 5), due to the use of the (fermented) cream cheese and the addition of lemon zest, lemon juice or citric acid.

Cheesecake comes mainly in two varieties, with a cold set filling type, or a baked type. The firmness of the cold set cheesecake filling is normally obtained via structure forming ingredients, such as cold gelling agents like gelatin or certain phosphates, which will cause solidification of the cheesecake filling at about room temperature. For the baked type cheesecake, the filling (as well as the crust) is solidified as a result of the heating process because of the presence of whole eggs, cream and starch.

A special type of cheesecake is so-called New York—style cheesecake, a product that is also of the baked type and contains a relatively high amount of fat, as compared to the European, low fat (quark based) cheesecake.

Baked cheesecake can also be produced on industrial scale by using a dry ingredient blend and cream cheese. The blend contains a number of ingredients such as sugar, starches, flour, thickening agents, milk powder, emulsifiers, vegetable oil, food acids and salt.

For the cheesecake preparation, the cream cheese, the ingredient blend and whole egg are mixed, optionally more ingredients may be added such as cream and/or water; the filling is then layered on a dough and baked in an oven. After baking, the cheesecake is cooled and left to rest. Once cooled down, the prepared cheesecake can be frozen for long-term storage and transport to the retail.

One problem that may occur with baked cheesecake, however, when using a method involving the use of a dry ingredient blend, and frequently also in the traditional method using fresh ingredients, is that after baking, the filling may form cracks, probably due to shrinking of the filling matrix. Crack formation may also occur on freezing the cheesecake.

Another defect observed with ingredient blends is that the final taste and structure of the final cheesecake is not always acceptable.

As a result, the industrial baker will need to discard the defective cheesecakes, being unsaleable and hence forms a financial loss. Furthermore, it appeared that the sensory properties of the filling did not meet the standards of a high quality cheesecake, for instance New York-style cheesecake.

U.S. Pat. No. 3,455,698 relates a dry food mix which is reconstitutable as a cheesecake filling comprising a major portion of an acid coagulable protein source, sugar, flour, cornstarch and an acidogen which is hydrolysable in water to release an edible acid.

WO 2004-008868 relates to a shelf-stable, bakeable savory cheese product, and a process for preparing it. The product is prepared as a three-phase formulation, including an aqueous liquid phase, a dispersed fat phase and a solids phase. The products can be applied to unbaked doughs prior to baking and retain their desired properties after baking.

US 2001-0002267 describes a low moisture cheesecake product having extended shelf life stability. The product is obtained by setting predetermined water activity ranges for the crust and the filling, thereby extending the shelf life at least until 3 months.

US 2014-0170285 relates to a method for the production of room-temperature stable cheesecake filling and the cheesecake filling obtainable by this method. The method described comprises mixing cheese, a stabilizer, water and preferably an anti-oxidizing agent, heating the mixture, mixing eggs with sugar, combining the cheese- and egg containing phases, and heating, followed by cooling of the phases. The mixture thus obtained may be kept for several months at room temperature.

US 2010-0178388 pertains to a fluffy, bake-stable filling that is formed by mixing fat ingredients, such as soybean oil, and a fiber ingredient, such as oat fiber. The fibers may be admixed with optional ingredients, such as cheese powder, whey protein power, salt, yeast enhancer, and paprika.

JP 2019-50738A relates to a cheese cake-like food product which includes at least cheese, an emulsifier, whey protein, and glucomannan, in which the emulsifier includes at least one type selected from a group consisting of diacetyl tartaric acid monoglyceride, succinic acid monoglyceride, and enzyme-decomposed lecithin. The whey protein is preferably at least one type selected from a group consisting of non-refined whey, whey protein concentrate, and whey protein separated matter.

The prior art however has so far not offered a solution to the above-mentioned problems associated with cheesecake.

Therefore, the need exists to provide an improved cheesecake and an improved method to prepare such a cheesecake of which preferably the filling will not form cracks after baking, and has an good taste and mouthfeel.

### SUMMARY OF THE INVENTION

It has now been found that the use of certain whey proteins included in a dry powder and which is used in a baked cheesecake preparation method surprisingly could diminish or even prevent the formation of cracks in the filling after baking, and produce very good tasting cheesecakes.

Accordingly, in one aspect, the invention relates to a baked cheesecake comprising a crust and a filling wherein the filling comprises 2-7 wt. % , based on the dry weight of the filling, of whey protein preferably derived from a whey protein source comprising at least 34% whey protein by weight.

In another aspect, the invention further relates to a method for preparing a baked cheesecake comprising the steps of
a) providing cream cheese;
b) providing a powdered ingredient composition comprising a whey protein source preferably comprising at least 34% native whey protein by weight;
c) mixing the cream cheese and the powdered ingredient composition to obtain a filling;
d) providing a dough for the crust;
e) combining the filling obtained in step c) and the dough provided in step d) to obtain a pre-cheesecake composition;
f) baking the pre-cheesecake composition to obtain the cheesecake.

In another aspect, the invention relates to a method for preparing an unbaked pre-cheesecake composition comprising the steps of
a) providing cream cheese;
b) providing a powdered ingredient composition comprising a whey protein source preferably comprising at least 34% native whey protein by weight;
c) mixing the cream cheese and the powdered ingredient composition to obtain a filling;
d) providing a dough for the crust;
e) combining the filling obtained in step c) and the dough provided in step d) to obtain an unbaked pre-cheesecake composition.

In another aspect, the invention relates to an unbaked pre-cheesecake composition, preferably obtainable by or obtained by the method as described just above comprising a crust and a filling wherein the filling comprises 2-7 wt. %, based on the dry weight of the filling, of native whey protein preferably derived from a whey protein source comprising at least 34% whey protein by weight.

In a yet another aspect, the inventions relates to a powdered ingredient composition suitable for preparing a cheesecake filling comprising, based on total weight of the composition, 4-30 wt. % of a whey protein source preferably comprising at least 34% whey protein by weight, 25-45 wt. % fat and 30-45 wt. % carbohydrates.

In a further aspect, the invention relates to the use of native whey protein concentrate and/or native whey protein isolate for the reduction of preferably prevention of cracks in the filling of a baked cheesecake.

### DETAILED DESCRIPTION

### Definitions.

Throughout the specification, the terms “fat” and “oil” are considered to be interchangeable. “Fat” may have the same meaning as “oil”.
“Milk fat” is the lipid part or fractions thereof as present and obtainable from bovine raw milk. “Fat” or “oil” consists mainly of fatty acid triglycerides; preferably more than >95 wt. %.
The “native state of whey protein” is determined by its NSI pH 4.6 value, expressed as a percentage.
A “crack” in a cheesecake filling is defined as a visible interruption of the surface or the side walls, extending to the inside of the filling.
“Native starch” is a term used for starch that is extracted from vegetable sources such as wheat, maize, tapioca or potato. It is insoluble in cold water, and is not chemically, physically or thermally modified.
“Whole egg” or “whole egg solids” is defined as egg material containing both egg yolk and egg white (albumen), preferably in their relative amounts as present in chicken eggs.

The invention relates, in one aspect, to a baked cheesecake comprising a crust and a filling wherein the filling comprises 2-7 wt. %, based on the dry weight of the filling, of whey protein preferably derived from a whey protein source comprising at least 34% whey protein by weight.

It has been found that the use of whey proteins from a certain source in amounts according to the invention, substantially reduces or even prevents crack formation in the filling after the baking process; crack formation is considered to be a very undesirable and unattractive feature in cheesecake.

It has further been observed that the whey protein content of the whey protein source used may be of importance. A minimum level of 34 wt. % whey protein in the whey protein source is preferred. Without being bound to any specific theory, it is surmised that in order to achieve a high enough whey protein level in the filling according to the invention it is preferred not to just add any whey protein source to obtain the required whey protein content, because the other constituents which are present in the whey protein source, such as (mainly) lactose and salts, may cause the solids content of the filling to be become much too high. The baker working with low whey protein sources such as whey powder and WPC 30, may have to adapt the recipe thereby deviating significantly from the cheese cake filling recipe.

The whey proteins used in the invention are preferably derived from bovine milk.

Preferably, the filling comprises 2.5-6.5 wt. %, more preferably 3-6 wt. %, most preferably 3,5-5.5 wt. %, based on the dry weight of the filling, of whey protein preferably derived from a whey protein source comprising at least 34% whey protein by weight.

Preferably, the whey protein source comprises whey protein concentrate and/or whey protein isolate. The term whey protein concentrate (WPC) is known in the art and relates to whey protein preparations that are obtained by purification and/or concentration steps of whey, preferably bovine whey. A conventional process to produce whey protein concentrates is e.g. via (membrane) ultrafiltration (UF), optionally followed by diafiltration (DF). WPC's have, in the art, a whey protein content of between 30-85% based on dry weight. Whey protein isolates (WPI) can be prepared by UF/DF, or by ion-exchange processes. The whey protein content of WPI's lies generally between 85-95 wt. % based on dry weight. See for instance P. Walstra et al., CRC Press, Dairy

Science and Technology, 2006, second edition, page 541 .

The whey protein concentrate preferably comprises 34-85%, more preferably 35-80%, most preferably 60-80% of protein, by weight of the WPC. WPC's with a standardized amount of 35, 60 and 80% protein on dry weight are commercially available from e.g. FrieslandCampina (NUTRI WHEY NATIVE) , ARLA Foods, Leprino Foods, Eurial , and can hence be used for the purpose of the invention.

The whey protein isolate has preferably a protein content of more than 85% protein based on dry weight, most preferably 90 wt. % or more. The whey protein isolate preferably has a protein content of less than 95 wt. %. based on dry weight.

In one embodiment, the whey protein source comprises a combination of a WPC and a WPI.

In another embodiment, the whey protein source comprises one or more WPC's selected from the group of WPC 35, WPC60 and WPC80.

Whey protein sources such as WPC or WPI may be derived from cheese whey or acid whey. The skilled person is aware how these processes are run industrially; see f.i. P. Walstra et al., CRC Press, Dairy Science and Technology, 2006, second edition, pages 538-542.

The whey protein source most preferably comprises acid whey as it has been observed to give very good results in the preparation of the cheesecake filling.

In a most preferred embodiment, the whey protein source comprises a whey protein concentrate, preferably a WPC80, from acid whey.

The cheesecake filling may further comprise a vegetable fat or oil. Although the filling already contains milk fat derived from the cream cheese, it was found that the presence of vegetable oil provided the filling with a better mouthfeel. The amount of vegetable oil may be preferably between 5-40%, more preferably between 10-30% , most preferably between 12-25 wt. % based on dry weight of the filling. Preferably, the vegetable oil is selected from the group consisting of palm oil, palm kernel oil, coconut oil, rape seed oil, soy bean oil and sunflower oil.

Most preferably, the vegetable oil is oil selected from the group consisting of palm oil and rapeseed oil, since it has been found that using these oils, the best taste of the filling is obtained.

The cheesecake filling further comprises milk fat, preferably in an amount of 5-40 wt. % , more preferably 10-35 wt. % , most preferably 15-30 wt. % based on dry weight of the filling.

In the cheesecake filling, the total amount of fat is preferably between 15 and 60 wt. %, more preferably between 20 and 52 wt. %, most preferably between 25 and 48 wt. % , based on dry weight of the filling.

Additionally, the cheesecake filling may comprise carbohydrates. The carbohydrates may comprise mono-, di- and/or oligosaccharides, preferably in amounts of 20-30 wt. % based on dry weight of the filling. Carbohydrates serve as sweeter, and to provide body to the filling.

Oligosaccharides are defined herein as chains of 3-10 monosaccharides. Preferred oligosaccharides may comprise glucose syrup and/or maltodextrin. Suitable mono- and/or disaccharides comprise sucrose, and glucose. Most preferred is sucrose.

Advantageously, the filling does not comprise too high levels of lactose to avoid sandiness of the filling. Therefore the filling comprises, based on dry weight of the filling, less than 15 wt. %., preferably less than 13 wt. %, more preferably less than 12 wt. %. most preferably less than 11 wt. % lactose.

The cheesecake filling preferably additionally may comprise milk protein other than the whey protein, preferably in an amount of 4-8 wt. %, more preferably 5-7 wt. %. Such a milk protein comprises most preferably casein.

The pH of the cheesecake filling is approximately pH 5, preferably between pH 4.6 and 5.1, more preferably between 4.7 and 5.0. Herein, the pH measurement is carried out by thoroughly mixing 1 wt. part of water and 1 wt. part of cheesecake filling, and measuring the pH with a calibrated pH meter at 20° C.

In a preferred embodiment, the cheesecake filling comprises 2-6 wt. %, based on the dry weigh of the filling, of whey protein preferably derived from a whey protein concentrate which comprises 35-80 wt. % protein by dry weight of the whey protein concentrate; 10-30 wt. % of a vegetable oil, 10-30 wt. % of milk fat; 20-30 wt. % of carbohydrates; and 4-8 wt. % milk proteins other than the whey protein source.

In a most preferred embodiment, the cheesecake filling comprises 2-6 wt. %, based on the dry weight of the filling, of whey protein preferably derived from a whey protein concentrate which comprises 60-80 wt. % protein by dry weight of the whey protein concentrate; 10-30 wt. % of vegetable oil selected from the group of palm oil and rapeseed oil , 10-30 wt. % of milk fat; 20-30 wt. % of mono-, di- and/or oligosaccharides, and 4-8 wt. % of casein.

In the course of the investigations for the invention, it was observed that whole egg as part of the cheesecake filling may have a negative effect on the quality of the filling in such a way that it appeared to enhance crack formation at the filling surface after baking. Therefore, preferably, the cheesecake filling may contain less than 6 wt. %, more preferably less than 2 wt. %, even more preferably less than 0.5 wt. % whole egg solids, based on the dry weight of the filling. Most preferably, the filling contains no whole egg solids.

In another aspect, the invention further relates to a method for preparing a baked cheesecake comprising the steps of
a) providing cream cheese;
b) providing a powdered ingredient composition comprising a whey protein source preferably comprising at least 34% native whey protein by weight;
c) mixing the cream cheese and the powdered ingredient composition to obtain a filling;
d) providing a dough for the crust;
e) combining the filling obtained in step c) and the dough provided in step d) to obtain a pre-cheesecake composition;
f) baking the pre-cheesecake composition to obtain the baked cheesecake.

The cream cheese provided in step a) may be a conventional cream cheese as described in the background. The skilled person is aware how to obtain such products. Suitable types of cream cheese are e.g. Philadelphia Original (KraftHeinz) and Mon Chou (FrieslandCampina).

Optionally, the cream cheese in step a) may first be mixed with an amount of water. This will result in an easier handling of the cream cheese. The skilled person will be able to determine the proper amount of water to be added, depending on the firmness of the cream cheese. Preferably, the amount of water mixed with the cream cheese in step a) is 15-25 wt. % based on the total weight of the cream cheese.

Cream cheese may contain various amounts of fat, ranging from about 21-43 wt. % on total product. The amount of carbohydrates, mainly lactose, ranges from 3-8 wt. % on total product; the amount of protein is normally in the range of 4-8 wt. %. It may further contain thicker and/or stabilizers such as guar gum, locust bean gum, carob, and added salt, such as sodium chloride. The dry solids content of the cream cheese is generally more than 30 wt. %; the dry solids content is preferably lower than 60 wt. %.

The powdered ingredient provided in step b) is defined as described hereinbelow as yet another aspect of the invention.

Preferably, in the method, a limited or no amount of whole egg, either liquid or powder, is used. Hence, preferably, in step a)-c), the amount of whole egg solids used is such that the cheesecake filling contains preferably less than 6 wt. %, more preferably less than 2 wt. %, even more preferably less than 0.5 wt. % , most preferably no whole egg solids, based on the dry weight of the filling.

As stated in the background relating to the invention, the filling of the cheesecake needs to be firm enough to be cut or sliced, and still have excellent sensory properties such as good eating experience; it may not be too hard, too soft, too brittle, too crumbly or too rubbery.

Hence, in order to obtain a proper firmness of the filling and to reduce or preferably avoid crack formation after baking, preferably, the cream cheese and powdered ingredient composition may be used in specific relative amounts. Hence, the cream cheese and powdered ingredient composition are used in step c) in such amounts that, based on the dry weight of the filling, the cream cheese provides for 25-50 wt. % of the solids in the filling, and the powdered ingredient composition provides for 45-65 wt. % of the solids in the filling of the cheesecake obtained in step f). More preferably, the cream cheese provides for 30-45 wt. % of the solids in the filling, and the powdered ingredient composition provides for 50-60 wt. % of the solids in the filling.

The dough for the crust provided in step d) can be prepared by the skilled person as a matter of routine; it may be hand-made by making a blend of crushed cookies, fat and sugar; or a ready-made dough may be obtained from a dough supplier.

In step e), the dough (step d) and the filling (step c) are combined, e.g. by depositing the filling on the dough. The skilled person is well aware how to carry out this step and choosing the proper tools to achieve this. The end-result of step e) is a pre-cheesecake composition.

The baking in step f) is a critical process, as during this step, the final structure of the filling is formed. The skilled person is aware of the criticality of this step, and will know how to adjust the settings of the oven with regards to heating temperature and residence time in the oven.

Small-scale baking may take place in a deck oven, whereas for large scale production (several 1000 cakes per day) normally a tunnel oven is used. In a deck oven, a static baking temperature is maintained. For instance, a heating time of 100 minutes at 115° C. is applied.

In a tunnel oven, various heating sections may be present each with its own temperature settings. Heating times even up to 185° C. for 50 minutes may be used.

However, for a proper structure formation of the filling, the temperature of the core of the filling must be taken into account, irrespective of the type of oven used. The very moment the core of the filling reaches a temperature of between 80-85 ° C., the heating is stopped. For a deck oven, this will mean removing the cheesecake from the oven and allow it to cool preferably at room temperature, i.e. around 20° C. For a tunnel oven, the cheesecake will enter a cooling section.

The core temperature of the filling can be monitored by inserting a calibrated temperature probe in a predetermined position of the cake filling. Accordingly, the baking in step f) preferably comprises heating the pre-cheesecake composition in an oven until a core temperate of the filling of between 80-85° C. is reached, after which the cheesecake obtained is cooled to about room temperature, preferably about 20° C., wherein the core temperature of the filling is measured preferably using a calibrated thermometer of which the tip is positioned at the centerpoint of the filling. The centerpoint is defined as the point that lies halfway the diameter of the filling at half the height of the filling.

Preferably the shape of the filling is circular, following the shape of the baking tin.

Optionally, the baked cheesecake can subsequently be frozen e.g. at −20° C. and stored for further distribution.

The baking of the pre-cheesecake composition may also take place later in a separate step. The pre-cheesecake composition may for instance be kept refrigerated, and baked off at another place and/or time.

Therefore, in another aspect, the invention relates to a method for preparing an unbaked pre-cheesecake composition comprising the steps of
a) providing cream cheese;
b) providing a powdered ingredient composition comprising a whey protein source preferably comprising at least 34% native whey protein by weight;
c) mixing the cream cheese and the powdered ingredient composition to obtain a filling;
d) providing a dough for the crust;
e) combining the filling obtained in step c) and the dough provided in step d) to obtain an unbaked pre-cheesecake composition.

In another aspect, the invention thus also relates to an unbaked pre-cheesecake composition, preferably obtainable by or obtained by the method as just specified above, comprising a crust and a filling wherein the filling comprises 2-7 wt. % , based on the dry weight of the filling, of native whey protein preferably derived from a whey protein source comprising at least 34% whey protein by weight.

The amounts and types of ingredients used and the steps taken to prepare the unbaked pre-cheese composition are, with the exception of the baking step, identical as described in the aspects of the invention relating to the baked cheesecake and its preparation method.

In a yet another aspect, the invention relates to a powdered ingredient composition suitable for preparing a cheesecake filling comprising, based on total weight of the composition, 4-30 wt. % of a whey protein source preferably comprising at least 34% whey protein by weight, 25-45 wt. % fat and 25-50 wt. % carbohydrates, preferably selected from the group of sucrose, glucose and glucose syrup and mixtures thereof.

Preferably, the powdered ingredient composition contains, on a dry weight basis, less than 8 wt. %, more preferably less than 7 wt. %, most preferably less than 6 wt. % of lactose. A too high lactose level will cause sandiness in the final filling.

The powdered ingredient composition may now conveniently be mixed with cream cheese, after which cheesecake can be baked and crack formation is strongly reduced or even absent in the filling after baking, and excellent sensory properties are obtained.

The powdered ingredient composition preferably has a dry solids content of more than 95 wt. %.

The powdered ingredient composition comprises preferably 5-28 wt. % , more preferably 6-25 wt. %, most preferably 7-23 wt. % of a whey protein source comprising at least 34% whey protein by weight,

The powdered ingredient composition preferably comprises 3-12 wt. %, more preferably 4-10 wt. %, most preferably 5-9 wt. % whey protein, based on dry weight of the a powdered ingredient composition. It has been found that a lower whey protein amount will not lead to a firm enough filling; on the other hand, a higher whey protein amount will lead to a too hard structure that has no resemblance with a baked cheesecake; and will not be appreciated by consumers.

Preferably, the whey protein source comprises, or is, a whey protein concentrate (WPC) or a whey protein isolate (WPI). In one embodiment, the whey protein source may comprise both a whey protein concentrate and a whey protein isolate.

In another embodiment, the whey protein source comprises one or more WPC's selected from the group of WPC 35, WPC60 and WPC80.

The whey protein concentrate preferably comprises 34-85%, more preferably 35-80%, most preferably 60-80% of protein, by weight of the WPC.

The whey protein isolate preferably has a protein content of more than 85% protein based on dry weight, most preferably 90 wt. % or more. The whey protein source most preferably comprises acid whey as it has been observed to give very good results in the preparation of the cheesecake filling. Hence, in a most preferred embodiment, the whey protein source comprises a whey protein concentrate, preferably a WPC80, from acid whey.

It is preferred that the whey protein in the powdered ingredient composition is in essentially native state. Whey protein that is in essentially native state is essentially not denatured, which means its tertiary, spatial, globular structure is still intact. For the purpose of the invention, it appeared that using a whey protein in essentially native state is very beneficial. Whey protein in a native state displays a high solubility at both neutral and low pH. Accordingly, whey protein in essentially native state is defined as having a nitrogen solubility index at pH 4.6 (NSI pH 4.6) of more than 75%, preferably of more than 85%, more preferably of more than 90%, most preferably of more than 93%.

The NSI pH 4.6 of whey protein is determined using the following method (derived from ISO 15323:2002/IDF173):
a) Weigh an amount of product equivalent to about 1 gram of protein in a beaker
b) Add 75 ml of 0.1 M NaCl solution
c) Adjust the pH to 4.6 using HCl, keep stirring the dispersion for 2 hrs. at 22° C.
d) Transfer the dispersion to a 100 ml flask, and fill with water till the 100 ml mark
e) Take a sizable sample from the flask and measure the nitrogen content
f) Transfer 35 ml of the remaining dispersion to a centrifuge tube and centrifuge at 3000 g at 22° C. for 10 minutes
g) Determine the nitrogen content of the supernatant. Nitrogen is determined using the Kjeldahl method according to ISO 8968-1/IDF 20-1.

$$N S I = \frac{{w}_{s}}{{w}_{d}} \times 100 \%$$

### Where

NSI is the nitrogen solubility index of the sample, expressed as a percent;
ws is the nitrogen content of the supernatant liquid obtained in step g), expressed as grams per 100 ml;
wd is the nitrogen content of the dispersion obtained in step e), expressed as grams per 100 ml.

The Kjeldahl method is also used for the determination of the protein content of compositions according to the invention (milk protein such as whey protein and casein), using a nitrogen conversion factor or 6.38.

The powdered ingredient composition preferably comprises 1-10 wt, % , more preferably 1.5-7 wt. %, most preferably 2-6 wt. % native starch, based on dry weight of the composition. Preferred native starch types comprise wheat starch, maize starch, tapioca starch and/or potato starch; most preferred is native wheat starch. By using native starch, it has been found that the use of modified starch and/or acid resistant starch is not necessary anymore. The native starch provides, in combination with the whey protein source, for a good structure development of the cheesecake filling during baking.

If present, the amount of starch in the powdered ingredient composition should be calculated separate from the carbohydrates already present in the composition.

The amount of fat in the powdered composition is preferably 28-42 wt. %, more preferably 30-40 wt. %, based on dry weight of the composition. The fat can be refined natural i.e. non-hydrogenated fat, or alternatively fully hydrogenated, hardened fat.

The fat in the powdered ingredient composition according to the invention may further comprise a vegetable oil, preferably selected from the group consisting of palm kernel oil, rape seed oil, coconut oil, palm oil, soy bean oil, sunflower oil, and medium chain triglyceride oil. More preferably the vegetable oil is selected from the group consisting of palm kernel oil, palm oil, rape seed oil, and coconut oil. Most preferably the oil comprises palm oil or rapeseed oil. The use of palm oil or rapeseed oil appeared to provide the best taste and mouthfeel and in line with what a consumer would expect from a baked cheesecake.

In a preferred embodiment, the fat is present as a spray dried fat powder. Hence, in a preferred embodiment, the powdered ingredient composition comprises, on a dry weight basis of the powdered ingredient composition, 30-55 wt. %, more preferably 35-50 wt. %, most preferably 40-45 wt. of a spray dried fat powder, which fat powder preferably comprises, on dry weight basis of the fat powder, 83-87 wt. % fat, 10-15 wt. % carbohydrates, preferably glucose syrup, and 1-3 wt. % protein, preferably milk protein, such as caseinate.

The use of fat in the form of a powder enables easy handling of the fat in the preparation of the powdered ingredient composition, as opposed to including liquid or solid fat as such.

Such a fat powder is preferably made by spray drying an emulsion of fat, carbohydrates such as maltodextrin or glucose syrup, and protein. An example of such a fat powder is Vana Grasa® 80C 058 which is based on refined palm oil, or Vana Grasa® 80 B 065, based on rapeseed oil; both are available from FrieslandCampina Ingredients, The Netherlands.

Carbohydrates comprised in the powdered ingredient composition may further be selected from sucrose, dextrose, glucose syrup, maltodextrin, fructose and high fructose corn syrup.

The powdered ingredient composition may further comprise one or more components selected from the group of dried egg yolk powder, wheat flour, food grade acidulants, thickening agents, flavors, aroma's and salt. Egg yolk powder may be present preferably in an amount 1-10, more preferably 2-9, most preferably 3-8 wt. %, based on dry weight of the composition.

Wheat flour may be present in the ingredient composition in an amount of 3-8 wt. %.

Food grade acidulants may preferably be selected from citric acid, lactic acids, malic acid, and/or the salts derived therefrom; preferably these are present in such amounts that a pH of about 4.6-5.1 is obtained in the final cheesecake filling; more preferably, the food grade acidulants are preferably present in an amount of 0.1-2.5 wt. %, more preferably 0.5-1.8 wt. %, most preferably between 0.8-1.5 wt. %, based on dry weight of the composition.

Thickening agents may preferably be selected from the group consisting of guar gum, locust bean gum, xanthan gum, pectin, gelatin, gum Arabic, preferably in amounts of 0.01-5 wt. %, more preferably 0.02-3 wt. %, most preferably 0.05-1.5 wt. % based on dry weight of the composition. Most preferred thickening agents are guar gum, locust bean gum and xanthan gum.

Salt (sodium chloride), flavors and aromas such as lemon flavor and/or vanilla flavor are present in the powdered ingredient composition in amounts as required.

In a preferred embodiment, the powdered ingredient composition comprises, by weight of the composition, 8-15 wt. % of a whey protein concentrate comprising 60-80 wt. % protein, based on the dry weight of the whey protein concentrate and wherein the whey protein has an NSI pH 4.6 of more than 85%; 25-40 wt. % carbohydrates %, 30-40 wt. % vegetable oil and 2-8 wt. % native starch.

In a most preferred embodiment the powdered ingredient composition comprises, by weight of the composition, 8-12 wt. % of a whey protein concentrate comprising 80 wt. % protein, based on the dry weight of the whey protein concentrate and wherein the whey protein has an NSI pH 4.6 of more than 90%; 25-40 wt. % carbohydrates %, 30-40 wt. % oil selected from the group consisting of palm oil and rapeseed oil, and 2-8 wt. % native wheat starch.

In a further aspect, the invention relates to the use of whey protein concentrate and/or whey protein isolate for the reduction or preferably prevention of cracks in the filling of a baked cheesecake.

The amounts of whey protein concentrate and/or whey protein isolate used in the cheesecake are provided hereabove under the description of the aspect relating to the cheesecake.

Preferably, the whey protein concentrate and/or whey protein isolate is comprised in a powdered ingredient composition as described hereabove for the aspect relating to the powdered ingredient composition.

### DESCRIPTION OF FIGURES

FIG. 1: Baked cheesecake prepared according to the steps detailed in example 1 according to the invention.

FIG. 2: Baked cheesecake prepared according to the steps detailed in example 2A according to the invention.

FIG. 3: Baked cheesecake prepared according to the steps detailed in example 2B according to the invention.

FIG. 4: Baked cheesecake prepared according to the steps detailed in example 2C according to the invention.

FIG. 5: Baked cheesecake prepared according to the steps detailed in example 2D according to the invention.

FIG. 6: Baked cheesecake prepared according to the steps detailed in example 2E according to the invention.

FIG. 7: Baked cheesecake prepared according to the steps detailed in example 2F according to the invention.

FIG. 8: Baked cheesecake prepared according to the steps detailed in example 2G according to the invention.

### EXPERIMENTAL SECTION

### Materials and Methods

Thermometer (for measuring core temperature) : TD11 type T, probe length 108 mm, obtained from VWR, the Netherlands.
Oven type : MIWE Deck oven (MIWE, Germany).

### Example 1

An example according to the invention was made as follows.

### Ingredients:

975 grams Philadelphia Cream Cheese 22 wt. % fat, 31.5 wt. % dry matter (KraftHeinz)
220 grams Water
574 grams of a powder mixture comprising
   30 g Egg yolk powder
   216 powdered sugar
   0.5 g guar gum (Dupont)
   0.025 g flavor
   0.1 g salt
   24 g native wheat starch
   48 g NUTRI WHEY NATIVE , a native WPC80 prepared from acid whey (FrieslandCampina Ingredients) NSI=91.0%
   250 g Vana Grasa 80 C 058 (palm oil based fat powder; composition: 80.5 wt. % refined palm oil, 17 wt. % glucose syrup, 2 wt. % sodium caseinate)
   1.4 g Citric acid.
Crust ingredients (conventional, made by crushing Bastogne cookies and mixing with melted butter- or equivalent).

### Preparation:

Prepare the crust dough and press it in a suitable baking tin (diameter 27 cm). Mix the cream cheese with water using a Hobart mixer equipped with a butterfly stirrer until a smooth mixture is obtained.
Add the powder mixture to the cream cheese mix and stir for 2 minutes at medium speed. Fill the baking tin with the mix.
Bake at 115° C. in a MIWE deck over (MIWE, Germany) until a core temperature of the filling of 82-85° C. is obtained.
Cool the cheesecake to ambient temperature. Optionally, the cake can be frozen and stored at −20° C., and defrosted before consumption.

### Results.

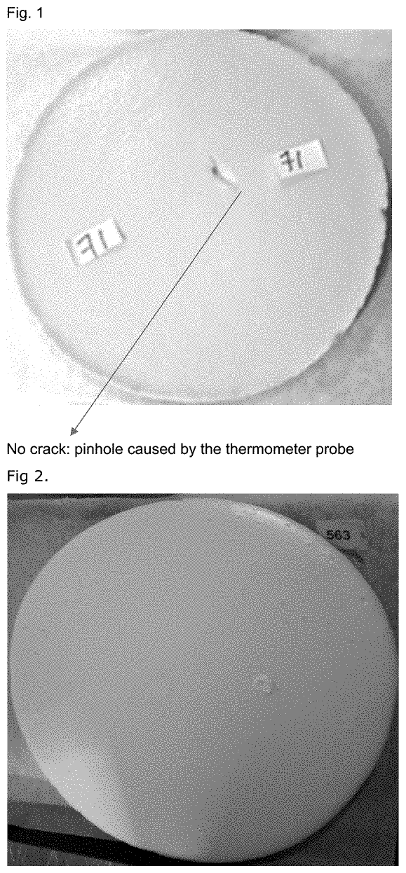

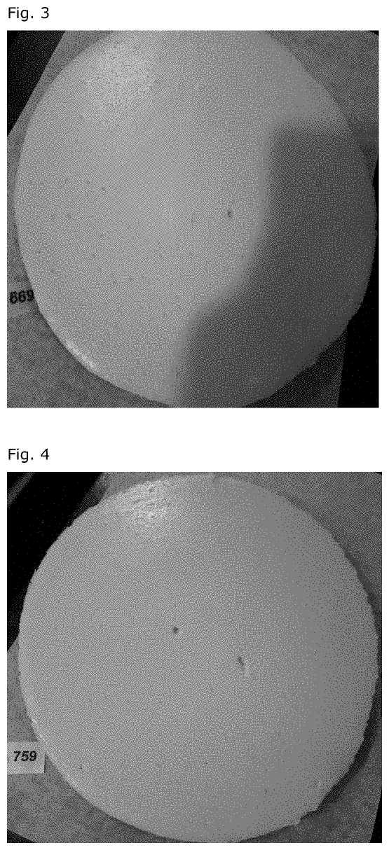

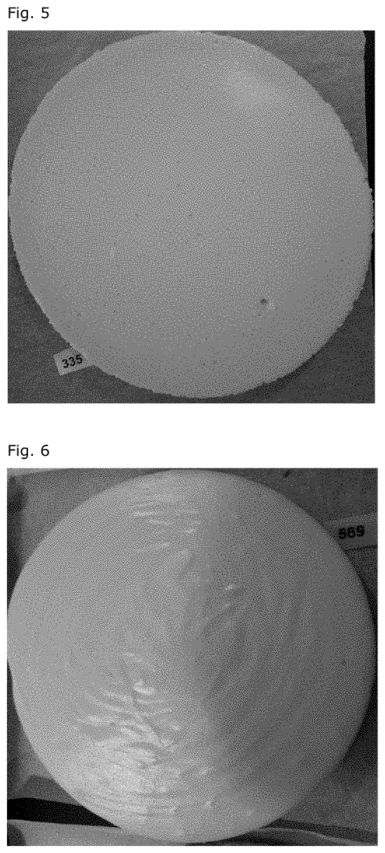

The cheesecake obtained from experiment 1 (containing 4.4 wt. % whey protein derived from WPC 80) based on dry matter of the filling) had a nice, smooth surface which did not show any cracks after baking (see FIG. 1), and neither after freezing at −20° C. nor after subsequent defrosting. No moisture was visible on the surface.

The cheesecake, in particular the filling, was evaluated for structural and sensory aspects:
Structure: excellent structure, easy to cut, not crumbly, not too hard.
Sensory: full, rich flavor, very good aftertaste, a feeling of indulgence; creamy mouthfeel.

### Example 2

Further experiments were carried out with different whey protein sources, and without whey protein.
7 Different ingredient blends were prepared and combined with Philadelphia cream cheese, and subsequently baked as described in example 1.
As vegetable fat source, Vana Grasa 80B 065 (FrieslandCampina Ingredients) was used, which has the following composition: 80.2% refined rapeseed oil, 15.3 wt. % glucose syrup, 2.5 wt. % sodium caseinate, 1.9 wt. % anticaking agents and phosphates.
The compositions were as described in Table 1: compositions 2A-2C were according to the invention, 2D -2G were comparative examples.

TABLE 1
Composition of the fillings.

| | 2A | 2B | 2C |
|---|---|---|---|
| Ingredients: (grams) | | | |
| Philadelphia cream cheese | 975 | 975 | 975 |
| Water | 220 | 220 | 220 |
| Egg yolk powder | 30 | 30 | 30 |
| Sucrose | 216 | 157 | 202 |
| Guar gum | 0.5 | 0.5 | 0.5 |
| Citric acid | 1.4 | 1.4 | 1.4 |
| Flavor | 0.025 | 0.025 | 0.025 |
| Sodium Chloride | 0.1 | 0.1 | 0.1 |
| Native wheat starch | 24 | 24 | 24 |
| Vana Grasa 80B 065 | 200 | 250 | 250 |
| NUTRI WHEY NATIVE | 48 | | |
| (WPC80) | | | |
| Hiprotal 35 (WPC 35)* | 107 | | |
| WPC 60** | | | 62 |
| Whey protein content on dry | 4.8 | 4.3 | 4.3 |
| matter of the filling (wt. %) | | | |

*Obtainable from FrieslandCampina Ingredients
**Obtainable from Havero Hoogwegt, The Netherlands.

Both WPC 35 and 60 are native whey proteins and are derived from cheese whey.
Comparative, not according to the invention:

| | 2D | 2E | 2F | 2G |
|---|---|---|---|---|
| Ingredients (grams) | | | | |
| Philadelphia cream cheese | 975 | 975 | 975 | 975 |
| Water | 220 | 220 | 220 | 178 |
| Egg yolk powder | 30 | 30 | 30 | 0 |
| Sucrose | 139 | 216 | 127 | 216 |
| Guar gum | 0.5 | 0.5 | 0.5 | 0.5 |
| Citric acid | 1.4 | 1.4 | 1.4 | 1.4 |
| Flavor | 0.025 | 0.025 | 0.025 | 0.025 |
| Sodium Chloride | 0.1 | 0.1 | 0.1 | 0.1 |
| Native wheat starch | 24 | 24 | 24 | 24 |
| Vana Grasa 80B 065 | 250 | 250 | 250 | 250 |
| ESPRION 300 (WPC 30)* | 125 | | | |
| Denatured WPC 80** | | 48 | | |
| Cheese Whey Powder | | | 136 | |
| Whole egg | | | | 120 |
| Whey protein content on dry | 4.2 | 4.4 | 1.7 | 0 |
| matter of the filling (wt. %) | | | | |

*Available from FrieslandCampina Ingredients
**prepared by heating (boiling) for 20 minutes a native WPC 80 (NUTRI WHEY NATIVE) solution and then drying; NSI < 30%.

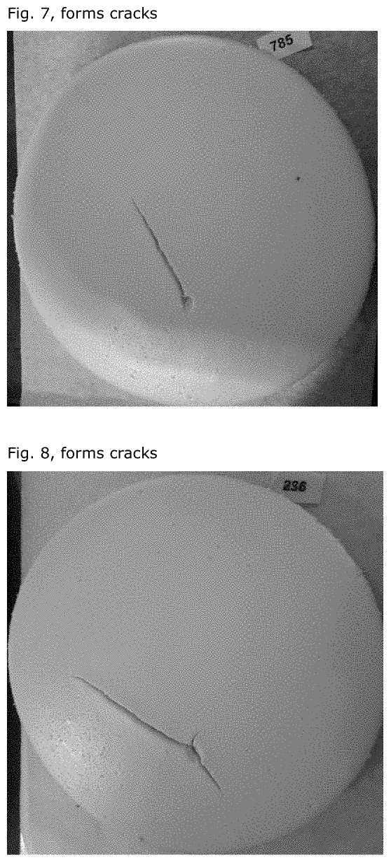

The cheesecakes were prepared as described in Example 1.
After baking, the cheesecakes were inspected for cracks. It appeared that samples 2F (made with cheese whey) and 2G (made with whole egg and no whey protein) formed cracks, see FIGS. 7 and 8. These were unsuitable results and were not further evaluated on sensory aspects.
Samples 2A-2E did not show any cracks, and these were tested for sensory acceptance using a panel of 16 persons, who were given samples of the test cakes under a randomized 3 digit number—the panel members did not know what the cheesecakes contained. The panel was asked to rate the samples on a scale of 1 (dislike extremely)-9 (like extremely) for appearance, taste and mouthfeel. The panel members were also asked to provide comments. A rating of 5.5 or higher was found to be acceptable.

TABLE 2
Results of sensory assessment.

| Sample | 2A | 2B | 2C | 2D | 2E |
|---|---|---|---|---|---|
| Overall | 5.8 | 6.1 | 5.7 | 5.2 | 3.8 |
| liking on | | | | | |
| appearance, | | | | | |
| taste and | | | | | |
| mouthfeel | | | | | |
| Comments | Sweet, | Firm, not | Shiny, full, | Slimy, soft, | Particles |
| of panel | creamy, | too sweet, | creamy, | falls apart, | present, |
| members | smooth, | shiny, | sweet, | sticky | sandy, |
| | balanced | creamy, | balanced | | grainy, fat |
| | taste, firm | balanced | | | droplets, |
| | | taste, | | | flat taste, |
| | | smooth, | | | off-taste |
| | | neutral | | | |
| | | taste | | | |

The test showed the much better performance of cheesecake fillings comprising 2-7 wt. % of whey protein originating from a source wherein the whey protein is in the native form and/or wherein the whey protein source comprises at least 34 wt. % of whey protein

1. A baked cheesecake, comprising a crust and a filling, wherein the filling comprises 2-7 wt. %, based on the dry weight of the filling, of whey protein.

2. The cheesecake according to claim 1, wherein whey protein is derived from a source comprising at least 34% whey protein by weight.

3. The cheesecake according to claim 1, wherein the source comprises whey protein concentrate and/or whey protein isolate.

4. The cheesecake according to claim 1, wherein the whey protein source comprises acid whey.

5. The cheesecake according to claim 1, wherein the filling further comprises 5-40 wt. %, based on the dry weight of the filling, vegetable oil.

6. A method for preparing a baked cheesecake according to claim 1, comprising:
(a) mixing cream cheese and a powdered ingredient composition comprising a whey protein source to obtain a filling;
(b) combining the filling with dough to obtain a pre-cheesecake composition;
(c) baking the pre-cheesecake composition to obtain the baked cheesecake.

7. The method according to claim 6, wherein the whey protein source comprises at least 34% native whey protein by weight.

8. The method according to claim 7, wherein the cream cheese and powdered ingredient composition are used in such amounts that, based on the dry weight of the filling, the cream cheese provides for 25-50 wt. % of the solids in the filling, and the powdered ingredient composition provides for 45-65 wt. % of the solids in the filling.

9. A powdered ingredient composition suitable for preparing a cheesecake filling comprising, based on total weight of the composition:
(a) 4-30 wt. % of a whey protein source,
(b) 25-45 wt. % fat, and
(c) 25-50 wt. % carbohydrates.

10. The powdered ingredient composition, wherein the whey protein source comprises at least 34% whey protein by weight.

11. The powdered ingredient composition according to claim 10, wherein the composition comprises 3-12 wt. % whey protein based on dry weight of the composition.

12. The powdered ingredient composition according to claim 9, wherein the whey protein source comprises a whey protein concentrate or whey protein isolate.

13. The powdered ingredient composition according to claim 9, wherein the whey protein is in essentially native state.

14. The powdered ingredient composition according to claim 9, further comprising 1-10 wt. % native starch.

15. The powdered ingredient composition according to claim 9, wherein the fat comprises vegetable oil.

16. The powdered ingredient composition according to claim 9, further comprising one or more components selected from the group of dried egg yolk powder, wheat flour, food grade acidulants, thickening agents, flavors, aromas and salt.

17. A method of reduction or prevention of cracks in filling of a baked cheesecake, comprising, adding to the filling native whey protein concentrate and/or whey protein isolate.

18. A method for preparing an unbaked pre-cheesecake composition, comprising:
(a) mixing cream cheese and a powdered ingredient composition comprising a whey protein source to obtain a filling;
(b) combining the filling with dough to obtain an unbaked pre-cheesecake composition.

19. An unbaked pre-cheesecake composition, comprising a crust and a filling, wherein the filling comprises 2-7 wt. % , based on the dry weight of the filling, of native whey protein.

20. The method according to claim 19, wherein the whey protein source comprises at least 34% native whey protein by weight.
